(19) United States
(12) Patent Application Publication
(10) Pub. No.: US 2017/0039823 A1
(43) Pub. Date: Feb. 9, 2017

(54) HOSPITAL EQUIPMENT EVENT INTERFACE

(71) Applicant: Rauland-Borg Corporation, Mount Prospect, IL (US)

(72) Inventors: Karthik N. Srivathsa, Palatine, IL (US); Bin Yang, Lisle, IL (US); John Poust, Evanston, IL (US); Robert Bak, Buffalo Grove, IL (US); Jennifer Holden, Mundelein, IL (US); Veronica Kagley, Arlington Heights, IL (US)

(21) Appl. No.: 15/228,764

(22) Filed: Aug. 4, 2016

Related U.S. Application Data
(60) Provisional application No. 62/201,027, filed on Aug. 4, 2015.

(51) Int. Cl. G08B 3/10; G06F 17/28

(52) U.S. Cl. CPC G08B 3/1016; G06F 17/28

(57) ABSTRACT

A system and method are provided for providing an integration interface for event messages being sent between nurse call devices and interface devices outside of the nurse call system. The system includes an integration interface server disposed between the nurse call system and the interface devices. The integration interface server includes an integration engine that performs a translation process on event messages received at the integration interface server. The translation process translates the event messages such that they can be understood by either the nurse call system or the interface devices. Further, the translation process is based on whether the event message was originally created to be sent to the nurse call system or the interface devices. In this manner, the integration interface server is configured to provide a common interface to and from the nurse call system for a variety of interface device types.

### CROSS-REFERENCE TO RELATED APPLICATIONS

This patent application claims the benefit of U.S. Provisional Patent Application No. 62/201,027, filed Aug. 4, 2015, which is incorporated by reference.

### FIELD OF THE INVENTION

This invention generally relates to nurse call systems, and more particularly to an event message interface between a nurse call system and devices that interface with the nurse call system.

### BACKGROUND OF THE INVENTION

A typical hospital includes many care units, such as an Intensive Care Unit (ICU), a Cardiology Unit, an Emergency Care Unit, a General Surgery Unit, an Oncology Unit, a Pediatrics Unit, and a Pharmacy Unit, among others. Further, each of these units requires associated staff members and equipment to provide care for patients of the hospital.

Hospitals generally use a nurse call system to alert staff of varying needs of support in the hospital. Typically, a nurse call system is implemented over a hospital's internal network and utilized to update staff as to needed support within the care units of the hospital. The needed support is generally handled by a staff member assigned to a specific location or level of support within a hospital/hospital care unit.

In addition to the nurse call system, hospitals include a variety of medical devices. Over time, the medical devices have developed such that they generate various types of data that can be communicated to a nurse call system over the hospital's internal network. However, the various medical devices typically do not generate event messages of a standard format for a nurse call system, and therefore, the event messages from the various medical devices cannot directly be provided to the nurse call system. An event is defined as being but not limited to a status, alert, alarm, registration, and chart entry.

In addition to the variety of medical devices, a hospital may also include an Admit Discharge Transfer (ADT) system and Real Time Location Service (RTLS) system that also provide event messages to the hospital's internal network, and also may communicate those event messages in a non-standard format for a nurse call system. Therefore, event messages from the ADT system and the RTLS system cannot be directly provided to the nurse call system.

In view of the above, there is a need for a system that will function as a common interface for event messages from hospital medical devices, ADT systems, RTLS systems and other various network enabled hospital devices in order to communicate those event messages to the nurse call system. Embodiments of the invention provide such a solution for event message communication to the nurse call system. These and other advantages of the invention, as well as additional inventive features, will be apparent from the description of the invention provided herein.

### BRIEF SUMMARY OF THE INVENTION

One embodiment provides an event communication system for integrating medical equipment with a nurse call system within a hospital environment. The event communication system including a plurality of interface devices, a communication network, a plurality of nurse call devices, a nurse call server, and an integration interface server. The plurality of interface devices are associated with the hospital environment. The communication network is coupled to each of the plurality of interface devices. The plurality of nurse call devices are associated with the nurse call system of the hospital environment. The nurse call server is coupled to the communication network, and the nurse call server is configured to communicate with each of the plurality of nurse call devices. The nurse call system includes the nurse call server and the plurality of nurse call devices, and the integration interface server is communicatively coupled to the nurse call server and the plurality of interface devices and configured to translate event messages communicated between the nurse call server and the plurality of interface devices. The integration interface server includes an integration engine and a translation table. The integration engine is configured to parse the event messages, determine a routing direction to a destination device for the event messages, and structure the event messages into one of an interface device event message and a nurse call device event message. The translation table is configured to store message translation data, wherein the message translation data is accessed by the integration engine in order to structure the event messages to be readable by the destination device, wherein the interface device event message is readable by at least one interface device of the plurality of interface devices and the nurse call device event message is readable by the nurse call server.

Another embodiment includes a method of providing event messages to interface devices from a nurse call system in a hospital environment. The method includes receiving an event message at an integration interface server from a nurse call device of the nurse call system; performing a translation process on the event message at the integration interface server to obtain a translated event message; and sending the translated event message to an interface device from the integration interface server. The translation process includes parsing the event message received from the nurse call device to determine a device identifier and message content; searching a list of device identifiers for a plurality of interface devices for the device identifier stored in a integration interface database, wherein the integration interface database further stores network location information for each of the plurality of interface devices; conditionally obtaining the network location information of the interface device when the device identifier is found in the list of device identifiers; translating the message content by referencing a translation table stored at the integration interface server to obtain the translated event message, wherein the translation makes the message content readable by the interface device; and associating the translated event message with the network location information of the interface device

Yet another embodiment includes a method of providing an event message to a nurse call system from interface devices in a hospital environment. The method includes receiving an event message at an integration interface server from an interface device in the hospital environment, performing a translation process on the event message at the integration interface server to obtain a translated event message, and sending the translated event message to the nurse call system from the integration interface server. The translation process includes parsing the event message received from the interface device to determine a device identifier and message content; searching a list of device identifiers for a plurality of interface devices for the device identifier stored in a integration interface database, wherein the integration interface database further stores network location information for each of the plurality of interface devices; conditionally obtaining the network location information of the interface device when the device identifier is found in the list of device identifiers; translating the message content by referencing a translation table stored at the integration interface server to obtain the translated event message, wherein the translation makes the message content readable by nurse call system; and associating the device identifier with the translated event message.

### BRIEF DESCRIPTION OF THE DRAWING(S)

The accompanying drawings incorporated in and forming a part of the specification illustrate several aspects of the present invention and, together with the description, serve to explain the principles of the invention. In the drawings:

FIG. 1 is a block diagram illustrating a system for event messages in a hospital, according to an example embodiment;

FIG. 2 is a block diagram illustrating components of an interface server and nurse call server of FIG. 1, according to an example embodiment;

FIG. 3 is a flow diagram for providing event messages to an interface device from a nurse call system, according to an example embodiment;

FIG. 4 is a flow diagram for a translation process for event messages from a nurse call system to an interface device, according to an example embodiment;

FIG. 5 is a flow diagram for providing event messages from interface devices to a nurse call system, according to an example embodiment; and

FIG. 6 is a flow diagram for a translation process for event messages from interface devices to a nurse call system, according to an example embodiment.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

A typical hospital includes many care units, such as an Intensive Care Unit (ICU), a Cardiology Unit, an Emergency Care Unit, a General Surgery Unit, an Oncology Unit, a Pediatrics Unit, and a Pharmacy Unit, among others. Further, each of these units requires associated staff members and equipment to provide care for patients of the hospital.

Hospitals generally use a nurse call system to alert staff of varying needs of support in the hospital. Typically, a nurse call system is implemented over a hospital's internal network and utilized to update staff as to needed support within the care units of the hospital. The needed support is generally handled by a staff member assigned to a specific location or level of support within a hospital/hospital care unit.

In addition to the nurse call system, hospitals include a variety of patient medical devices. Over time, the patient medical devices have developed such that they generate various types of data that can be communicated to a nurse call system over the hospital's internal network. However, the variety of patient medical devices typically do not generate event messages of a standard format for a nurse call system, and therefore, the event messages from the patient medical devices cannot directly be provided to the nurse call system.

In addition to the variety of medical devices, a hospital may also include a Admit Discharge Transfer (ADT) system and Real Time Location Service (RTLS) system that also provide event messages to the hospital's internal network, and also may communicate those event messages in a non-standard format. Therefore, event messages from the ADT system and the RTLS system cannot be directly provided to the nurse call system.

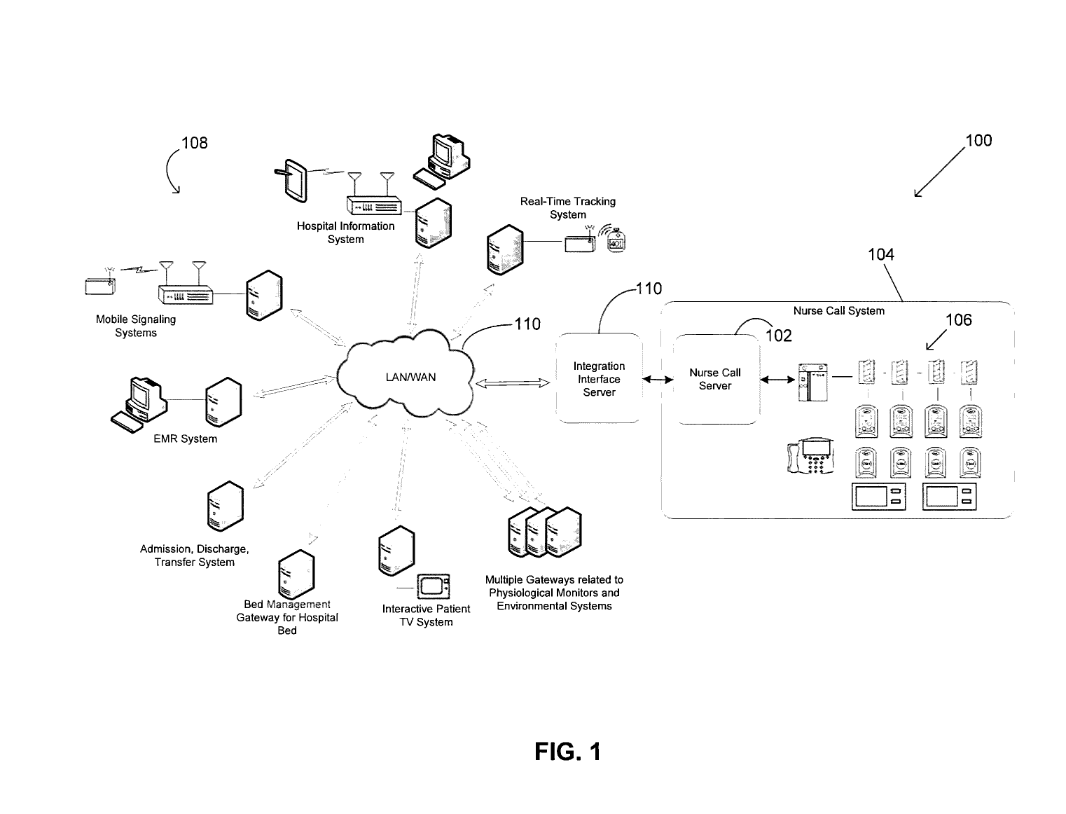

Accordingly, there is a need for a system that will function as a common interface for event messages from hospital medical devices, ADT systems, RTLS systems and other various network enabled hospital devices in order to communicate those event messages to the nurse call system. FIG. 1 illustrates an embodiment of the invention that provides such a solution to the above described need.

FIG. 1 illustrates a block diagram of a hospital's internal network 100. The network 100 includes a nurse call server 102 that communicates with a nurse call system 104 that includes nurse call devices 106. The nurse call devices 106 are generally devices such as corridor lights, bedside stations, bath stations, emergency call stations, a Session Initiation Protocol (SIP) interface, a personal computer (PC) console communicatively coupled to the hospital's internal network 100, a TAP interface, a patient station, and a staff terminal.

The nurse call server 102 connects to an integration interface server 110. The integration interface server 110 interfaces the hospital medical devices and other systems, such as the ADT system and the RTLS system, to the nurse call server 102. For convenience, the hospital medical devices and other systems will collectively be referred to as a plurality of interface devices 108. These interface devices 108 are distributed throughout a hospital's various individual care units and communicate with the integration interface server 110 through communication network 111. FIG. 1 contains a non-exhaustive listing of possible interface devices 108, such as a hospital information system (HIS), a RTLS system, an interactive patient television system, an Electronic Medical Record (EMR) system, an ADT system, a bed management gateway, a physiological monitor gateway, and a mobile signaling application gateway.

In certain embodiments, the nurse call server 102 may be formed from a plurality of interconnected servers or a plurality of services running on an individual server. Further, in certain embodiments, the integration interface server 110 may be formed from a plurality of interconnected servers or a plurality of services running on an individual server. While in other embodiments, the nurse call server 102 and the integration interface server 110 may be integrated into a single server cluster device. Additionally, in other embodiments, the nurse call server 102 and the integration interface server 110 may be implemented as cloud servers.

Regardless of the structural server implementation, the integration interface server 110 bridges a communication gap between the interface devices 108 and the nurse call server 102 and thereby the nurse call system 104. Generally, this communication is facilitated over an extensible markup language (XML) interface hosted by the integration interface server 110 that translates event messages received from both the interface devices 108 and the nurse call devices 106 and routes the translated event message to its intended destination. Further, as new types of interface devices 108 or nurse call devices 106 are added, the XML interface hosted by the integration interface server 110 is updated with new functionality to translate the event messages communicated to and from these devices. Accordingly, communication from the variety of interface devices 108 and the nurse call system 104 can be achieved in this manner.

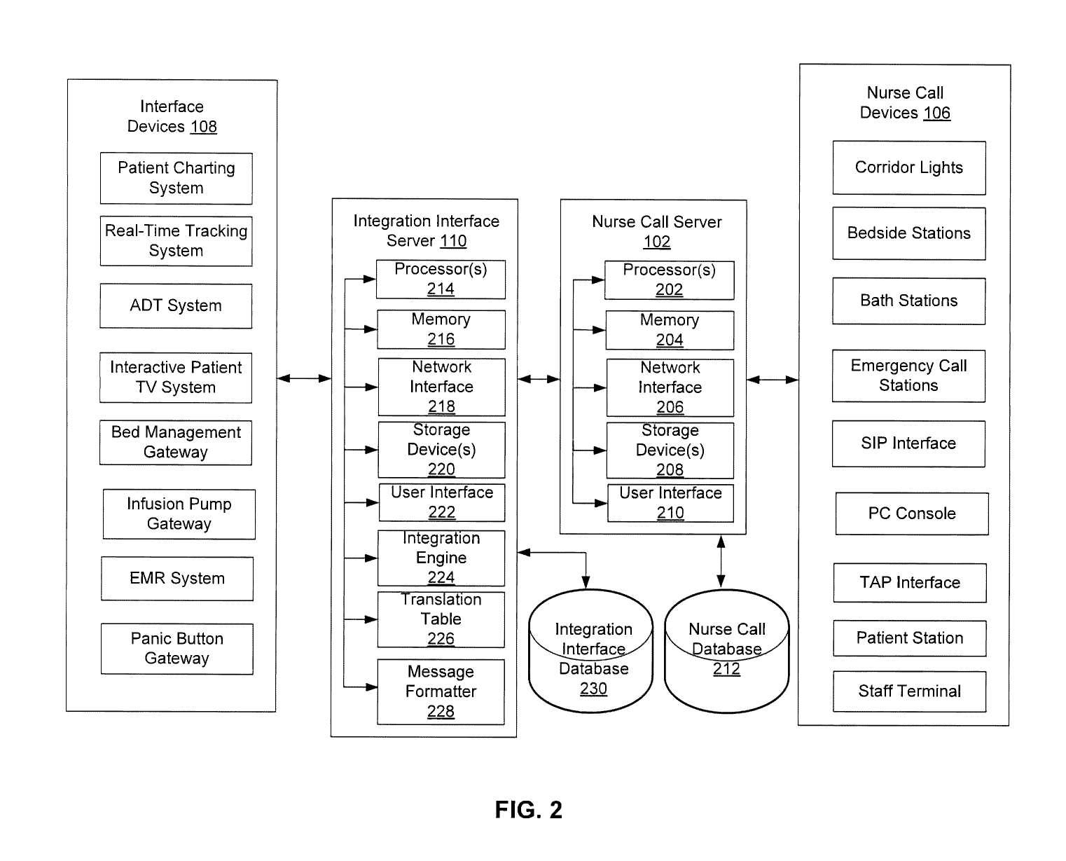

FIG. 2 provides a block diagram of the nurse call server 102 and the integration interface server 110 from FIG. 1, according to one embodiment of the disclosure. The nurse call server 102 includes one or more processors 202, memory 204, a network interface 206, one or more storage devices 208, and a user interface 210. In some embodiments, each of the components including the processor(s) 202, the memory 204, the network interface 206, the storage device(s) 208 and the UI 210 are interconnected physically, communicatively, and/or operatively for inter-component communications.

As illustrated, processor(s) 202 are configured to implement functionality and/or process instructions for execution within server 102. For example, processors 202 execute instructions stored in memory 204 or instructions stored on storage devices 208. Memory 204, which may be a non-transient, computer-readable storage medium, is configured to store information within server 102 during operation. In some embodiments, memory 204 includes a temporary memory, i.e. an area for information not to be maintained when the server 102 is turned off. Examples of such temporary memory include volatile memories such as random access memories (RAM), dynamic random access memories (DRAM), and static random access memories (SRAM). Memory 204 also maintains program instructions for execution by the processors 202.

Storage devices 208 also include one or more non-transient computer-readable storage media. Storage devices 208 are generally configured to store larger amounts of information than memory 204. Storage devices 208 may further be configured for long-term storage of information. In some examples, storage devices 208 include non-volatile storage elements. Non-limiting examples of non-volatile storage elements include magnetic hard discs, optical discs, floppy discs, flash memories, or forms of electrically programmable memories (EPROM) or electrically erasable and programmable (EEPROM) memories.

The server 102 uses network interface 206 to communicate with external devices via one or more networks, such as the network 110 of FIG. 1. Such networks may include one or more wireless networks, wired networks, fiber optics networks, and other types of networks through which communication between the server 102 and an external device may be established. Network interface 206 may be a network interface card, such as an Ethernet card, an optical transceiver, a radio frequency transceiver, or any other type of device that can send and receive information.

UI 210 is a network application hosted on the nurse call server 102 and provided over the network 111. In this regard, UI 210 acts to provide a user access to the nurse call server 102. This allows a user to change settings within the nurse call server 102 to customize nurse call functionality provided by the nurse call system 104 (see FIG. 1).

In certain embodiments, the nurse call server 102 accesses a nurse call database 212. The nurse call database 212 stores locations within the hospital environment and hospital staff and nurse call devices 106 located within the various locations. In this manner, the nurse call system 104 (see FIG. 1) can route data to the appropriate hospital staff member via the appropriate nurse call device 106, such as a staff terminal.

FIG. 2 further illustrates the integration interface server 110 coupled to the nurse call server 102. The integration interface server 110 includes one or more processors 214, memory 216, a network interface 218, one or more storage devices 220, a user interface (UI) 222, an integration engine 224, a message translation table 226 and a message formatter 228. In some embodiments, each of the components including the processor(s) 214, the memory 216, the network interface 218, the storage device(s) 220, the UI 222, the integration engine 224, the message translation table 226 and the message formatter 228 are interconnected physically, communicatively, and/or operatively for inter-component communications.

As illustrated, processor(s) 214 are configured to implement functionality and/or process instructions for execution within the integration interface server 110. For example, processors 214 execute instructions stored in memory 216 or instructions stored on storage devices 218. Memory 216, which may be a non-transient, computer-readable storage medium, is configured to store information within integration interface server 110 during operation. In some embodiments, memory 216 includes a temporary memory, i.e. an area for information not to be maintained when the integration interface server 110 is turned off. Examples of such temporary memory include volatile memories such as random access memories (RAM), dynamic random access memories (DRAM), and static random access memories (SRAM). Memory 216 also maintains program instructions for execution by the processors 214.

Storage devices 220 also include one or more non-transient computer-readable storage media. Storage devices 220 are generally configured to store larger amounts of information than memory 216. Storage devices 220 may further be configured for long-term storage of information. In some examples, storage devices 220 include non-volatile storage elements. Non-limiting examples of non-volatile storage elements include magnetic hard discs, optical discs, floppy discs, flash memories, or forms of electrically programmable memories (EPROM) or electrically erasable and programmable (EEPROM) memories.

The integration interface server 110 uses network interface 218 to communicate with external devices, such as the interface devices 108 via the communication network 111 (see FIG. 1). This communication may occur over one or more wireless networks, wired networks, fiber optics networks, and other types of networks through which communication between the integration interface server 110 and the interface devices 108 may be established. Network interface 218 may be a network interface card, such as an Ethernet card, an optical transceiver, a radio frequency transceiver, or any other type of device that can send and receive information.

UI 222 is a network application hosted on the integration interface server 110 and accessible over nurse call devices 106, such as the PC console, via the nurse call server 102. In this regard, UI 222 acts to provide a user access to the integration interface server 110. This allows a user to change settings within the integration interface server 110 to customize interface functionality with the interface devices 108.

Integration engine 224 is an application hosted on the integration interface server 110. The integration engine 224 enables the integration interface server 110 to communicate with the interface devices 108 by performing a translation process on event messages such that the event messages are structured into one of an interface device event message or a nurse call device event message based on whether a destination device specified in the event message is a nurse call device 106 or an interface device 108. In order to perform this translation process, the integration engine 224 must parse incoming event messages. Parsing the incoming event messages enables the integration engine 224 to determine both a routing direction and event message content. Generally, where the nurse call system 104 is sending an event message to an interface device 108, the routing direction will be an identifier of a destination device or system. In the reverse situation, where an interface device 108 is sending the event message, an identifier will be associated with the event message such that the nurse call system 104 will know what device sent the event message.

Before the event message can be routed to the destination device or system, the integration engine 224 must translate the event message content such that it will be readable by the destination device. In order to translate the event message content, the integration engine accesses the message translation table 226, which stores various types of event messages for the various types of integration devices 108 along with a corresponding event message for the nurse call devices 106. In this manner, the integration engine 224 parses the event message and searches the message translation table 226 for the event message content. After finding the event message content, the integration engine 224 obtains the corresponding event message content for the destination device in the message translation table 226 and uses the obtained event message content for building either the nurse call device event message or the integration device event message, depending on the parsed routing direction. Subsequently, the integration engine 224 sends the nurse call device event message or the integration device event message to the destination device or system.

As an aside, in certain embodiments, the integration engine 224 and the message translation table 226 may be implemented on dedicated processor and memory devices of the integration interface server 110. Alternatively, in other embodiments, the integration engine 224 and the message translation table 226 may represent various states of the processor 214, and are defined by program instructions and/or data stored on the memory 216 or the storage device 220.

The integration interface server 110 accesses an integration interface database 230. The integration interface database 230 stores network location addresses for the interface devices 108 within the hospital environment. Each interface device 108 is stored in the integration interface database 230 as an identifier with an associated network location address. In this manner, when the integration engine 224 parses an event message meant to be delivered to an interface device 108, the integration engine 224 can search for the integration interface database 230 for the parsed identifier in order to look up an associated network location address for that interface device 108. After obtaining the associated network location address for that interface device 108, the integration engine 224 can route the interface device event message to that network location address.

The integration interface database 230 stores identifiers and network location addresses for interface devices 108. In this manner, when the integration engine 224 parses an event message and determines, based on the parsed identifier, that the message is a nurse call device event message, intended to be provided to the nurse call system 104, the integration engine 224 will just direct the nurse call device event message directly to the nurse call server 102. The nurse call server 102 will access the nurse call database 212 in order to determine the ultimate destination of the nurse call device event message. In this situation, the nurse call device event message will include the identifier of the interface device 108 that created the event message such that the nurse call system 104 can identify the interface device 108 and have its network location, as stored in the integration interface database 230.

In certain embodiments, the integration interface server 110 further includes a message formatter 228. The message formatter 228 interprets event messages in High Level 7 (HL-7) format. In embodiments where the integration interface server 110 includes the message formatter 228, interface device event messages are formatted into HL-7 prior to being sent to the destination interface device 108.

As an aside, in certain embodiments, the message formatter 228 may be implemented on dedicated processor and memory devices of the integration interface server 110. Alternatively, in other embodiments, the message formatter 228 functionality may be performed by various states of the processor 214, and are defined by program instructions and/or data stored on the memory 216 or the storage device 220.

Using the above described system components of the hospital's internal network 100 (see FIG. 1), the following exemplary descriptions of system use cases will be described. A first exemplary system operation description related to initiating an alert from an interface device 108, such as an physiological monitor, and subsequently canceling that alert from a nurse call device 106 will be described. Further, a second exemplary operation description will be described where an event message from an interface device is tied to an escalation chain in the nurse call system 104.

In the first exemplary system operation description, the interface device 108, in the form of the physiological monitor, may issue an alert for a bag empty in order to prompt hospital staff to inspect the physiological monitor and switch to a new bag. This alert, or in other words event message, is provided to the to the integration interface server 110 over the communication network 111. The integration engine 224 parses the event message and determines that it is directed to the nurse call system 104 (see FIG. 1) based on a parsed identifier being searched in the integration interface database 230 for a corresponding network location. The integration engine 224 also parses the event message content and searches the message translation table 226 to determine the corresponding event message content for the destination nurse call device 106 to form the nurse call device event message. The integration engine 224 then sends the nurse call device event message to the nurse call server 102, which provides the nurse call device event message to the relevant nurse call device 106 such that a hospital staff member attends to the physiological monitor.

After receiving the event message to attend to the physiological monitor alert, the hospital staff member may then cancel the alert from the physiological monitor or from a nurse call device such as a staff terminal or a PC console. For instance, the hospital staff member may access the UI 210 from a PC console and create an event message to cancel the alert at the physiological monitor. The PC console sends the event message to the nurse call server 102, which in turn sends the event message on to the integration interface server 110. At the integration interface server 110, the integration engine 224 parses the event message and determines that it is directed to an interface device 108 based on a parsed identifier. The integration engine 224 also parses the event message to determine event message content and searches the message translation table 226 to determine the corresponding event message content for the interface device 108 (physiological monitor) to form the interface device event message. The integration engine 224 then searches the integration interface database 230 for the identifier to determine a network location address for the parsed identifier. The integration engine 224 then sends the interface device event message to the physiological monitor at the network location address for the identifier. In response to receiving this event message, the physiological monitor cancels its alert. Also, in certain embodiments, the integration engine may send the interface device event message to an EMR system such that a record of the cancellation of the alert from the physiological monitor is made in the EMR system.

In the second exemplary system operation description, an interface device 108 may update an escalation chain within the nurse call system 104 (see FIG. 1). Similar to the description regarding the first exemplary system operation description above, when the physiological monitor created the alert and the integration interface server 110 sent the alert to the nurse call system 104, an escalation chain may be created within the nurse call system 104 in response to the alert. In this situation, rather than the alert being canceled from a PC console, the alert may be canceled from the physiological monitor itself by the hospital staff member who attended to the alert. In this situation, the cancellation would be provided to the nurse call system 104 similar to the original alert, in the form of a nurse call device event message. This event message would update the escalation chain in the nurse call system 104 created by the original alert from the physiological monitor. For instance, this update could cancel the escalation chain such that the nurse call system 104 no longer shows a need for a hospital staff member to attend to the physiological monitor.

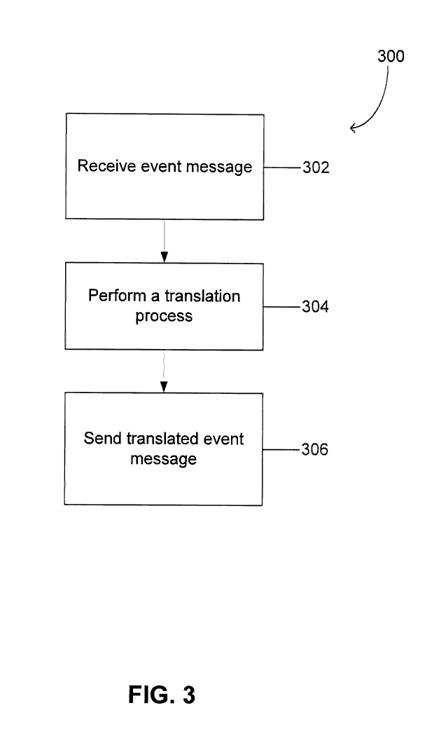

Turning now to FIG. 3, a flow chart 300 illustrating a method of providing event messages to interface devices 108 from a nurse call system 104 is shown. At step 302, the integration interface server 110 (see FIGS. 1 and 2) receives an event message from the nurse call system 104. At step 304 the integration engine 224 of the integration interface server 110 performs a translation process on the event message. After the conclusion of the translation process, at step 306, the integration interface server 110 sends the translated event message in the form of an interface device event message to an interface device 108.

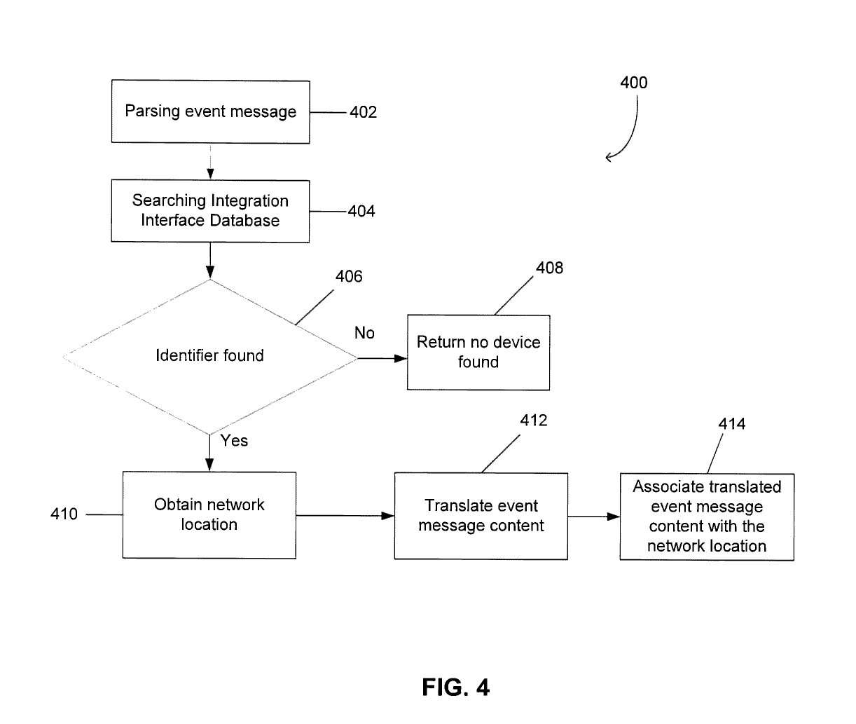

FIG. 4 illustrates translation process 400 referenced in FIG. 3. At step 402, the integration engine 224 (see FIG. 2) parses the event message received from the nurse call system 104 (see FIG. 1). The result of parsing the event message is that the integration engine 224 obtains an identifier of the destination device and event message content. At step 404, the integration engine 224 searches the integration interface database 230 for the identifier. At step 406, the translation process 400 checks for whether the identifier is found in the integration interface database 230. If the identifier is not found, then, at step 408, the integration engine 224 returns a no device found message to the nurse call system 104. Alternatively, if the identifier is found in the integration interface database 230, then the translation process 400 proceeds to step 410 where a network location address is obtained from the integration interface database 230. At step 412, the integration engine 224 translates the event message content by referencing the message translation table 226. At step 414, the integration engine 224 associates the translated message content with the obtained network location address in order to obtain the interface device event message, which can be sent to the interface device 108 at step 306 (see FIG. 3) of flow chart 300.

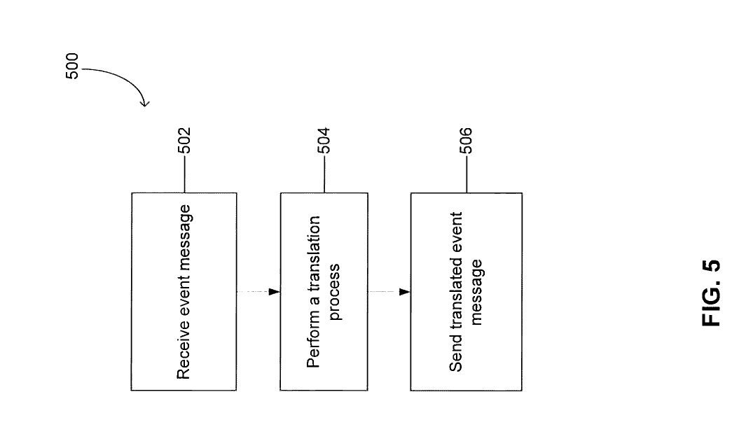

FIG. 5 illustrates a flow chart 500 showing a method of providing event messages to the nurse call system 104 (see FIG. 1) from the interface devices 108. At step 502, the integration interface server 110 (see FIGS. 1 and 2) receives an event message from an interface device 108. At step 504 the integration engine 224 of the integration interface server 110 performs a translation process on the event message. After the conclusion of the translation process, at step 506, the integration interface server 110 sends the translated event message in the form of a nurse call device event message to the nurse call system 104. In certain embodiments, this nurse call device event message could be an update to an escalation chain currently in force at the nurse call system 104.

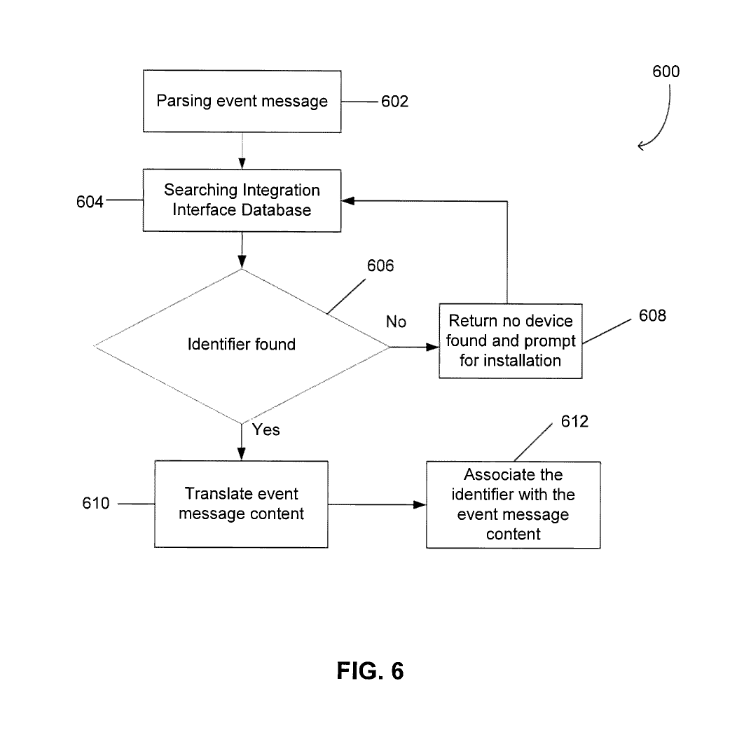

FIG. 6 illustrates translation process 600 referenced in FIG. 5. At step 602, the integration engine 224 (see FIG. 2) parses the event message received from the interface device 108. The result of parsing the event message is that the integration engine 224 obtains an identifier of the destination device and event message content. At step 604, the integration engine 224 searches the integration interface database 230 for the identifier. At step 606, the translation process 600 checks for whether the identifier is found in the integration interface database 230. If the identifier is not found, then, at step 408, the integration engine 224 returns a no device found message to the UI 222 of the integration interface server 110, and prompts whether a user of the UI 222 would like to install an identifier of the interface device 108 such that it will be recognized in the future, which after the installation the translation process 600 returns to step 604. Additionally, the installation would pertain installing corresponding event message translation entries into the message translation table 226. Alternatively, if the identifier is found in the integration interface database 230, then the translation process 400 proceeds to step 610 where the integration 224 engine translates the event message content by referencing the message translation table 226. At step 612, the integration engine 224 associates the translated message content with the identifier in order to obtain the nurse call device event message, which can be sent to the nurse call system 104 at step 506 (see FIG. 5) of flow chart 500. In this embodiment, the identifier associated with the nurse call device event message provides an indication of the interface device 108 that is sending the event message.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An event communication system for integrating medical equipment with a nurse call system within a hospital environment, the event communication system comprising:
a plurality of interface devices associated with the hospital environment;
a communication network coupled to each of the plurality of interface devices;
a plurality of nurse call devices associated with the nurse call system of the hospital environment;
a nurse call server coupled to the communication network, the nurse call server is configured to communicate with each of the plurality of nurse call devices, wherein the nurse call system includes the nurse call server and the plurality of nurse call devices; and
an integration interface server communicatively coupled to the nurse call server and the plurality of interface devices and configured to translate event messages communicated between the nurse call server and the plurality of interface devices,
wherein the integration interface server comprises:
an integration engine configured to parse the event messages, determine a routing direction to a destination device for the event messages, and structure the event messages into one of an interface device event message and a nurse call device event message; and
a translation table configured to store message translation data, wherein the message translation data is accessed by the integration engine in order to structure the event messages to be readable by the destination device, wherein the interface device event message is readable by at least one interface device of the plurality of interface devices and the nurse call device event message is readable by the nurse call server.

2. The system of claim 1, wherein the integration engine includes a message formatter that formats the event messages into HL-7 messages.

3. The system of claim 1, further comprising an integration interface database coupled to the integration interface server, wherein the integration interface database is configured to store an identifier of each of the plurality of interface devices.

4. The system of claim 3, wherein the plurality of nurse call devices includes a personal computer (PC) console, wherein the nurse call server is configured to receive a cancel alert event message from the PC console and relay the cancel alert event message to the integration interface server.

5. The system of claim 4, wherein the integration engine of the integration interface server parses the cancel alert event message for an identifier of the destination device and determines an identified destination device by comparing the identifier of the destination device to the identifier of each of the plurality of interface devices stored in the integration interface database.

6. The system of claim 5, wherein the integration engine accesses the translation table to access the message translation data to translate the cancel alert event message to an event message readable by the identified destination device.

7. The system of claim 6, wherein the integration engine routes the event message readable by the identified destination device to the identified destination device over the communication network thereby causing the identified destination device to cancel an alert initiated by the identified destination device.

8. The system of claim 1, wherein the plurality of interface devices comprises one or more of a bed management gateway, an electronic medical records (EMR) interface engine, an physiological monitor, and a mobile signaling application gateway.

9. The system of claim 1, wherein the plurality of nurse call devices comprises one or more of a Session Initiation Protocol (SIP) interface, a personal computer (PC) console, a TAP interface, a patient station, and a staff terminal.

10. The system of claim 3, wherein the identifier of each of the plurality of interface devices is associated with a network location address of each of the plurality of interface devices such that for each interface device of the plurality of interfaces devices an individual identifier and individual network location address are stored in the integration interface database on a one-to-one basis.

11. The system of claim 10, wherein the routing direction is determined at least partially on the network location address stored in the integration interface database.

12. A method of providing event messages to interface devices from a nurse call system in a hospital environment, the method comprising:
receiving an event message at an integration interface server from a nurse call device of the nurse call system;
performing a translation process on the event message at the integration interface server to obtain a translated event message; and
sending the translated event message to an interface device from the integration interface server,
wherein the translation process comprises:
parsing the event message received from the nurse call device to determine a device identifier and message content;
searching a list of device identifiers for a plurality of interface devices for the device identifier stored in a integration interface database, wherein the integration interface database further stores network location information for each of the plurality of interface devices;
conditionally obtaining the network location information of the interface device when the device identifier is found in the list of device identifiers;
translating the message content by referencing a translation table stored at the integration interface server to obtain the translated event message, wherein the translation makes the message content readable by the interface device; and
associating the translated event message with the network location information of the interface device.

13. The method of claim 12, wherein the translated event message clears an alert status at the interface device.

14. The method of claim 13, wherein the nurse call device is one of a Session Initiation Protocol (SIP) interface, a personal computer (PC) console, a TAP interface, a patient station, and a staff terminal.

15. The method of claim 14, wherein the interface device is one of a bed management gateway, an electronic medical records (EMR) interface engine, an physiological monitor, and a mobile signaling application gateway.

16. The method of claim 12, wherein the step of sending the translated event message to an interface device from the integration interface server comprises sending the translated event message to the network location information associated with the translated event message.

17. A method of providing an event message to a nurse call system from interface devices in a hospital environment, the method comprising:
receiving an event message at an integration interface server from an interface device in the hospital environment;
performing a translation process on the event message at the integration interface server to obtain a translated event message; and
sending the translated event message to the nurse call system from the integration interface server,
wherein the translation process comprises:
parsing the event message received from the interface device to determine a device identifier and message content;
searching a list of device identifiers for a plurality of interface devices for the device identifier stored in a integration interface database, wherein the integration interface database further stores network location information for each of the plurality of interface devices;
conditionally obtaining the network location information of the interface device when the device identifier is found in the list of device identifiers;
translating the message content by referencing a translation table stored at the integration interface server to obtain the translated event message, wherein the translation makes the message content readable by nurse call system; and
associating the device identifier with the translated event message.

18. The method of claim 17, wherein sending the translated event message updates an escalation chain active within the nurse call system.

19. The method of claim 18, wherein the interface device is one of a bed management gateway, an electronic medical records (EMR) interface engine, a physiological monitor, and a mobile signaling application gateway.

20. The method of claim 17, wherein communication between the interfaces devices and the nurse call system is facilitated by an extensible markup language (XML) interface hosted by the integration interface server.
